(19) United States
(12) Patent Application Publication
(10) Pub. No.: US 2010/0166492 A1
(43) Pub. Date: Jul. 1, 2010

(54) SECURITY PIN AND METHOD FOR MAKING THE SAME

(75) Inventor: Jun Wang, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/436,264

(22) Filed: May 6, 2009

(30) Foreign Application Priority Data
Dec. 27, 2008 (CN) 200810306585.4

(51) Int. Cl. F16P 7/00; F16D 9/06; B23P 17/00

(52) U.S. Cl. 403/2; 29/527.5

(57) ABSTRACT

A security pin includes a first sleeve, a second sleeve and a core. An end surface of the first sleeve contacts with an end surface of the second sleeve, and the core is positioned in the first sleeve and the second sleeve. The breakpoint of security pin is determined by the material and the size of the core. The core is not easily broken when applied by an external force. The security pin also has a relatively precise breakpoint.

### BACKGROUND

1. Technical Field

The present invention relates to a pin, especially relates to a security pin and method for making the same.

2. Description of the Related Art

Typically, security pin is a connecting member to connect work pieces. When applying an external force to the work pieces beyond a predetermined value, the security pin breaks to protect the work pieces.

Referring to FIG. 4, a conventional security pin 100 is substantially cylindrical, the typical security pin 100 includes a first portion 10, a second portion 12, and a breakable portion 14 interconnecting the first portion 10 and the second portion 12. A diameter of the breakable portion 14 is smaller than diameters of the first portion 10 and the second portion 12. Thus, a mechanical strength of the breakable portion 14 is lower than the mechanical strengths of the first portion 10 and the second portion 12. In use, the security pin 100 interconnects a first work piece 13 and a second work piece 15. The first member 13 defines a positioning hole 130 to receive the first portion 10, and the second member 15 defines a fixing groove 150 to receive the second portion 12. In assembling, the second portion 12 of the typical security pin 100 is inserted into the fixing groove 150 by pressing, such that the second portion 12 is interference fit in the fixing groove 150. The first member 13 is assembled on the second member 15 and the first portion 10 is fixed to the positioning hole 130. The breakable portion 14 is substantially coplanar with an interface of the first member 13 and the second member 15. When an external force is applied on the work pieces beyond the predetermined value, the security pin breaks at the breakable portion 14, protecting the first and second work pieces 13, 15.

A breakpoint of the typical security pin 100 is determined by the diameter of the breaking portion 14. However, in assembling, the breaking portion 14 is easily deformed. This can result in a mistaken positioning of the breakpoint of the breaking portion 14. In addition, the breaking portion 14 of the typical security pin 100 is usually achieved by a turning machine. However, it is difficult to precisely control the turning machine to form cutting grooves with uniform quality. This also increases the mistakes of the breakpoint of the security pin 100.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views, and all the views are schematic.

FIG. 1 is an exploded view of a first embodiment of a security pin.

FIG. 2 is a cross-sectional view of an exemplary embodiment of a security pin interconnecting with two work pieces.

FIG. 3 is a cross-sectional view of a second embodiment of a security pin interconnecting with two work pieces.

FIG. 4 is a cross-sectional view of a typical security pin interconnecting with two work pieces.

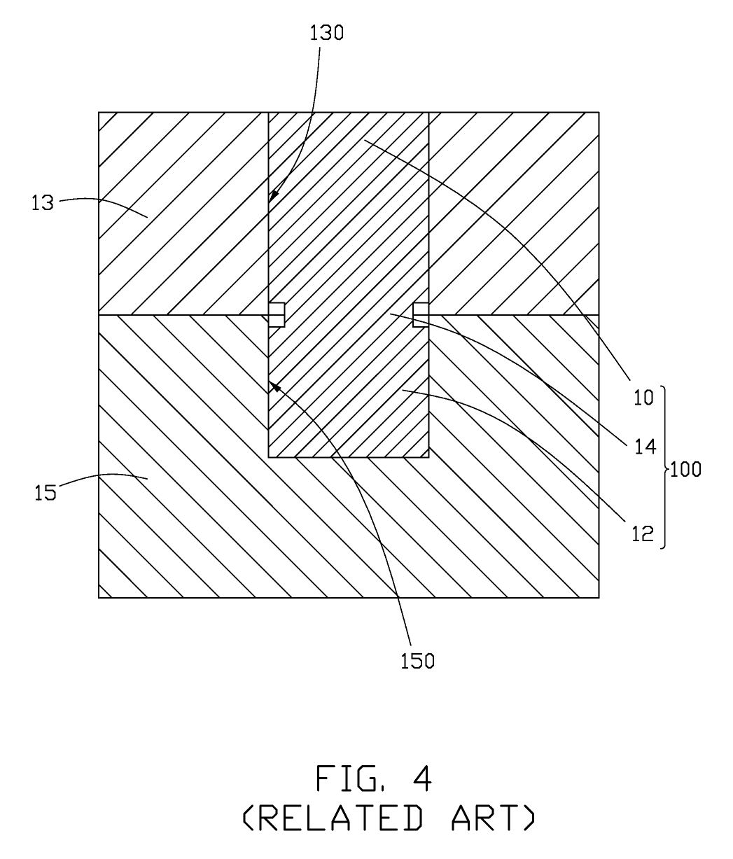

### DETAILED DESCRIPTION OF THE EMBODIMENTS

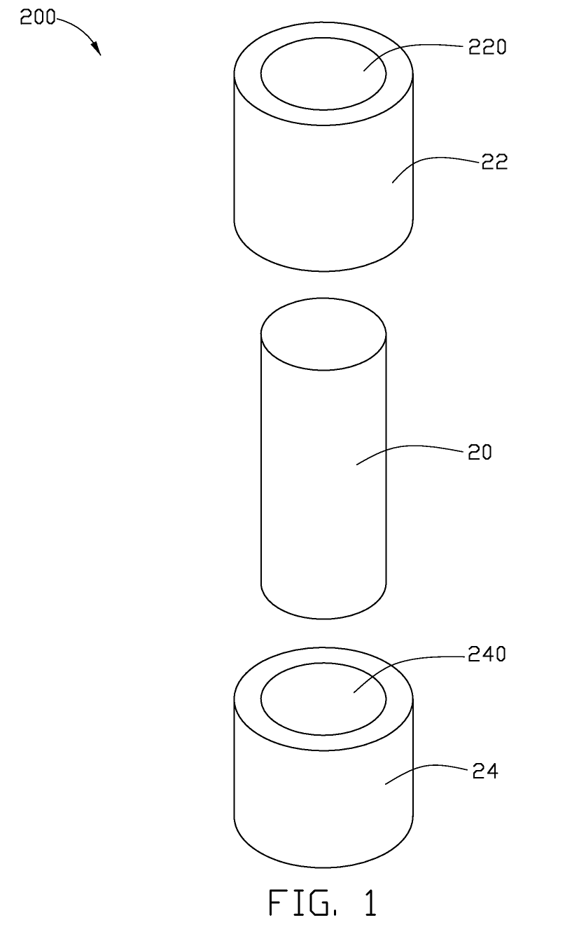

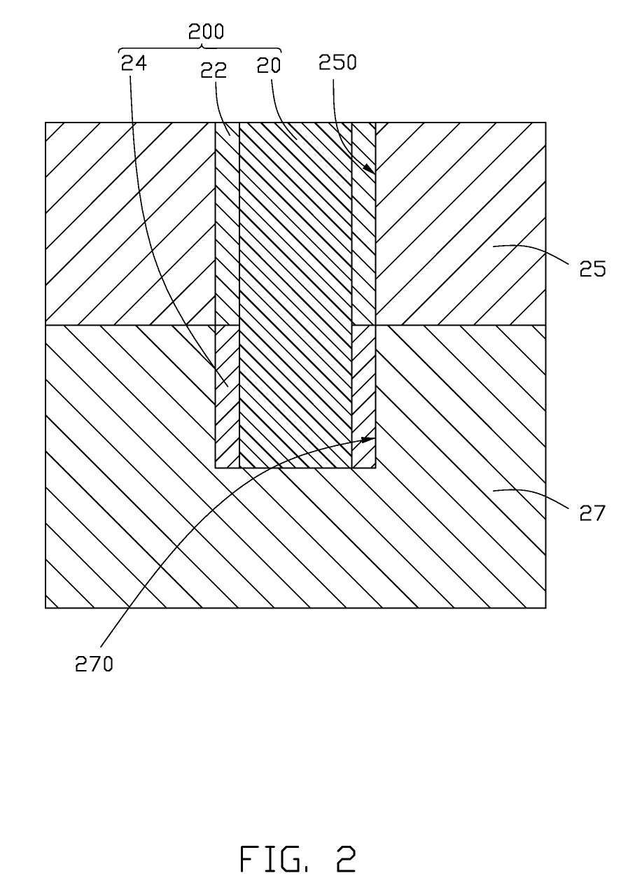

Referring to FIG. 1 and FIG. 2, a first exemplary embodiment of a security pin 200 includes a core 20, a first sleeve 22 and a second sleeve 24. The core 20 is substantially cylindrical, the inner diameter and the outer diameter of the first sleeve 22 and the second sleeve 24 are substantially the same. The first sleeve 22 defines a first receiving hole 220 to receive a first portion of the core 20, and the second sleeve defines a second receiving hole 240 to receive a second portion of the core 20. An end surface of the first sleeve 22 contacts with an end surface of the second sleeve 24 adjacent to the first sleeve 22. The first sleeve 22 and the second sleeve 24 are both made of high mechanical strength materials. The core 20 is made of materials having a lower mechanical strength than that of the first and second sleeves 22, 24. In this embodiment, the core 20 may be made of aluminum, and the first sleeve 22 and the second sleeve 24 may be made of steel. In alternative embodiments, the core 20 may be made of plastic or wood.

The security pin 200 is used for connecting a first work piece 25, and a second work piece 27. The first work piece 25 defines a positioning hole 250 to receive the first sleeve 22. The second work piece 27 defines a fixing groove 270 to receive to second sleeve 24. In assembling, the second sleeve 24 is hammered or pressed into the fixing groove 270, such that the second sleeve 24 is interference fit in fixing groove 270. The first work piece 25 is assembled on the second work piece 27 and the first sleeve is fixed to the positioning hole 250. Core 20 is then positioned. The interface of the first sleeve 22 and the second sleeve 24 is substantially coplanar with an interface of the first work piece. When an external force applied on the work pieces exceeds the predetermined value, the core 20 breaks at an interface of the first and second sleeves 22, 24, protecting the first and second work pieces 25, 27. In other words, the breakpoint of the security pin 200 is determined by a diameter of the core 20. Because the first and the second sleeve 22, 24 protect the core 20 from deforming when handling, the breakpoint of the security pin 200 is more precise.

A method for manufacturing the security pin 200 may include the following steps. Firstly, the first sleeve 22 and the second sleeve 24 are formed by extrusion forming or cast molding. Secondly, the first sleeve 22 and the second sleeve 24 are positioned in a casting mold. The end surface of the first sleeve 22 contacts with an end surface of the second sleeve 24, and the first receiving hole 220 communicates with the second receiving hole 240. Thirdly, a molten material is injected into the first receiving hole 220 and the second receiving hole 240. Finally, the molten material is cooled to form the core 20. In the manufacturing process, the inner diameter of the first sleeve 22 and the second sleeve 24 can be precisely controlled according to the material of the core 20, as a result the breakpoint of the security pin 200 is more precise due to the uniform diameter of the core 20.

In an alternative embodiment, the core 20 can be made of wood. The core 20 may be punched into the first sleeve 22 and the second sleeve 24.

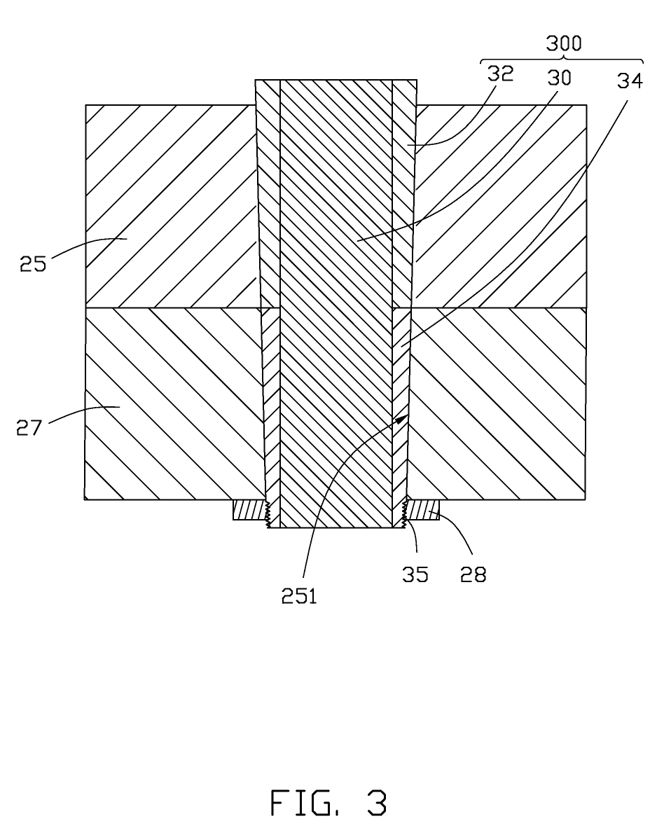

Referring to FIG. 3, a second embodiment of a security pin 300 similar in principle to the security pin 200 is shown. The first sleeve 32 and the second sleeve 35 have a same inner diameter. However, the security pin 300 is a conical frustum and longer than the security pin 200. The security pin 300 further includes a threading 35 formed on a smaller end portion of the security pin 300. The security pin 300 further includes a nut 28. Accordingly, a through hole 251 corresponding to the security pin 300 is defined in the first work piece 25 and the second work piece 27. The security pin 300 is inserted into the through hole 251, and both ends of the security pin 300 are exposed outside the first work piece 25 and the second work piece 27. The screwed nut 28 is screwed on the screwed thread 35, thereby, fixing the first work piece 25 to the second work piece 27.

Finally, while the embodiments have been described and illustrated, the present disclosure is not to be construed as being limited thereto. Various modifications can be made to the embodiments by those of ordinary skilled in the art without departing from the true spirit and scope of the embodiments as defined by the appended claims.

What is claimed is:

1. A security pin, comprising:
a first sleeve,
a second sleeve, and
a core, wherein the core is positioned in the first sleeve and the second sleeve, an end of the first sleeve contacting with an end surface of the second sleeve.

2. The security pin of claim 1, wherein both of the first sleeve and the second sleeve are made of steel.

3. The security pin of claim 2, wherein the core is made of aluminum.

4. The security pin of claim 2, wherein the core is made of plastic.

5. The security pin of claim 2, wherein the core is made of wood.

6. The security pin of claim 1, wherein the security pin is cylindrical, and an outer diameter of the first sleeve is equal to the outer diameter of the second sleeve.

7. The security pin of claim 1, wherein the security pin is wedge-shaped, and an outer diameter of the security pin decreases from one end thereof toward the other end thereof along an axial direction of the security pin.

8. A method of making a security pin comprising:
forming a first sleeve and a second sleeve, the first sleeve defining a first receiving hole and the second sleeve defining a second receiving hole;
providing a casting mold, and positioning the first sleeve and the second sleeve in the casting mold in a manner that an end surface of the first sleeve contacting with an end surface of an end surface of the second sleeve, the first receiving hole communicating with the second receiving hole;
injecting a molten material into the first receiving hole and the second receiving hole; and
cooling the molten material to form a core.
